(19) United States
(12) Patent Application Publication
(10) Pub. No.: US 2007/0220003 A1
(43) Pub. Date: Sep. 20, 2007

(54) System and method for collecting and/or managing data for remote service providers

(76) Inventors: Kevin W. Chern, Chicago, IL (US); Edmund J. Scanlan, Chicago, IL (US)

Correspondence Address: PATENTS+TMS, P.C., 2849 W. ARMITAGE AVE., CHICAGO, IL, 60647, US

(21) Appl. No.: 11/377,992

(22) Filed: Mar. 17, 2006

(51) Int. Cl. G06F 17/30

(52) U.S. Cl. 707/9

(57) ABSTRACT

A system and a method collect and/or manage data for remote service providers via a network for integrating and/or for incorporating a lead generation web application and/or a call center system with a case management web application. A potential client inputs information and/or data into an online form of a website of a host to indicate a desire to retain the services from one of the remote service providers. The call center system communicates with the host and contacts the potential client based on the data and/or information from the online form to conduct an inquiry of the potential client. The call center system identifies a location of the potential client and transfers the potential client to a local service provider which is local with respect to the location of the potential client. The host provides the case management web application to the remote service providers and/or the local service provider for maintaining, for organizing and/or for managing a file of a retained client and/or the potential client. The case management web application is populated with the data and/or the information from the online form. The case management web application identifies and/or provides parameters for the file of the retained client based on the services of the local service provider. A payment center is accessed via the network, the host and/or the case management web application for processing a transaction associated with the retained client, the local service provider and/or the services of the local service provider. The host searches the file of the retained client to identify and/or to determine supplemental services which may be desired by the retained client.

### BACKGROUND OF THE INVENTION

The present invention generally relates to a system and a method for collecting and/or managing data for remote service providers. More specifically, the present invention relates to a system and a method for collecting and/or managing data for remote service providers which may integrate and/or may incorporate a call center system and a case management web application via a network.

A client in a first location may access a website of a host via the network for collecting and/or for gathering the data which may be associated with the client. Advertising media and/or information associated with the remote service providers may be displayed to the client via the website for the user to identify services provided by the remote service providers.

The call center system may contact the client via email and/or via a telephone based on the data input into the website and/or the first location of the client. A local service provider which may be local with respect to the client may be identified and/or may be determined based on the data and/or the first location of the client. The call center system may link and/or may transfer the client to the local service provider via the network and/or via the telephone for the client to retain and/or to access the services of the local service provider. The host may populate and/or may provide the case management web application with the data from the client to aid, to assist and/or to support the local service provider with providing the services to the client. A financial institution may be connectable to the host via the network to process and/or to accept a payment from the local service provider for the case management web application and/or for a membership fee. The host may access and/or may search files associated with the case management web application via the network to identify and/or to determine whether supplemental services may be required by the client.

It is generally known, for example, that a user contacts a service provider via a telephone to inform the service provider of the services that the user desires to receiver from the service provider. For example, the user may desire to receive legal services or medical services from the service provider which may be local with respect to the user. The service provider notifies the user that the service provider offers the services desired by the user and inquires the user to determine if the user qualifies for the services provided by the service provider. After the inquiry, the service provider may determine that the user qualifies for the services provided by the service provider. As a result, the service provider establishes and/or opens a file associated with the user and/or the services desired by the user. The user and the service provider set and/or schedule an appointment and/or a meeting to enter into a service agreement between the user and/or the service provider. After the service agreement between the user and/or the service provider is established, the service provider may provide and/or may render the services for the user based on the service agreement.

It is also generally known, for example, that the user accesses a website of the service provider via the internet to examine, to determine and to identify the services provided by the service provider and/or a location of the service provider. Traditionally, the user inputs information into an online form on the website of the service provider to determine whether the user qualifies for the services of the service provider and/or whether the services of the service provider may aid and/or may assist the user. After the online form is submitted via the website, the information from the online form is reviewed by the service provider to determine whether the user qualifies for the services of the service provider. After the service provider reviews the information, an employee of the service provider contacts the user to conduct an inquiry and/or to establish a service agreement and/or service agreement between the service provider and the user. However, a desire of the user to receive and/or to retain the services from the service provider typically decreases as a duration of time between inputting the information into the online form and being contacted by the employee increases.

Traditionally, a call center may be used by a service provider to contact, to locate and/or to identify potential clients which may desire the services of the service provider. The call center may randomly contact the potential clients or may contact the potential clients based on third party data and/or the information from the online form. The potential clients may be remote with respect to the service provider and may desire to receive the services from a local service provider. As a result, the call center transfers the potential clients and/or the information from the online forms to the local service provider for contacting the potential clients, for conducting the inquiry, for establishing the service agreement and/or for rendering the services to the client. However, a desire of the potential clients to receive and/or to retain the services from the service provider typically decreases as a duration of time for transferring the potential clients from the call center to the local service provider increases.

Case management software is utilized by the service provider to develop, to manage, to maintain and/or to organize data and/or files of the clients, of existing clients and/or of the potential clients of the service provider. Traditionally, the case management software completes and/or executes features and/or functions which may be associated with and/or may be based on the services provided by the service provider and/or with the files of the existing clients. However, the case management software is not integrated and/or is not in communication with the call center and/or the website of the service provider. Moreover, the website, the call center and/or the case management software is typically owned and/or is typically operated by more than one service provider. As a result, the information collected and/or gathered via the online form, the website and/or the call center is not integrated with, is not populated into and/or is not incorporated into the case management software for managing the data and/or the files of the customers, of the existing clients and/or of the potential clients. As a result, the data and/or the files of the customers, of the existing clients and/or of the potential clients must be manually entered and/or must be manually exported into the case management software by one or more employees of the service provider. Manual entry and/or manually exportation is costly, is time consuming and/or reduces productivity of the service provider.

A need, therefore, exists for a system and a method for collecting and/or managing data for remote service providers. Additionally, a need exists for a system and a method for collecting and/or managing data for remote service providers which may maintain the desire of the user to retain the services from the service provider by minimizing the duration of time between inputting the information into the online form and being contacted by the employee increases. Further, a need exists for a system and a method for collecting and/or managing data for remote service providers which may maintain the desire of the potential clients to retain the services from the service provider by minimizing the duration of time for transferring the potential clients from the call center to the local service provider. Still further, a need exists for a system and a method for collecting and/or managing data for remote service providers which may integrate the case management software with the call center and/or the website of the service provider. Moreover, a need exists for a system and a method for collecting and/or managing data for remote service providers which may populate the case management software with the information collected via the online form, the website, the inquiry, the call center and/or the like. Furthermore, a need exists for a system and/or a method for collecting and/or managing data for remote service providers which may incorporate the information collected via the online form, the website, the inquiry and/or the call center into data and/or a file within the case management software.

### SUMMARY OF THE INVENTION

The present invention generally relates to a system and a method for collecting and/or managing data for remote service providers. The system and method may provide a network for integrating and/or for incorporating a lead generation web application and/or a call center system with a case management web application. A potential client may access a website of a host for obtaining information relating to services provided by the remote service providers. The user may input information and/or data into an online form of the website to indicate a desire to retain the services from the remote service providers. The call center system which is in communication with the host may contact and/or may link to the potential client based on the data and/or the information from the online form to conduct an inquiry of the potential client. The call center system may identify a location of the potential client and may transfer the potential client to a local service provider which may be local with respect to the location of the potential client.

The host may provide the case management web application to the remote service providers and/or the local service provider for maintaining, for organizing and/or for managing a file of a retained client and/or the potential client. The case management web application may be populated with and/or may incorporate the data and/or the information from the online form provided via the network and/or the call center system. The case management web application may identify and/or may provide parameters for the file of the retained client based on the services of the local service provider. A payment center may be connected to and/or may be accessed via the network, the host and/or the case management web application for processing a transaction associated with the retained client, the local service provider and/or the services of the local service provider. The host may search the file of the retained client and/or the case management web application to identify and/or to determine supplemental services which may be desired by the retained client.

In an embodiment of the present invention, a system for collecting and managing data associated with a user is provided. The system has a database wherein a website is associated with the database wherein the database is accessible by a computer network wherein the data of the user is input to the database via the website. The system has a call center accessible by the database and the computer network wherein the call center communicates with the user via the computer network based on the data of the user wherein a location of the user is identified by the call center or the data of the user wherein a location of the user is remote with respect to the call center. Moreover, the system has a first service provider connectable to the call center via the computer network wherein the first service provider is selected based on the location of the user wherein the call center transfers the user and the data of the user to the first service provider via the computer network wherein the first service provider accesses software via the computer network wherein the data of the user is input into a file via the call center and the computer network wherein the software manages a file associated with the user.

In an embodiment, the first service provider is an attorney.

In an embodiment, a location of the first service provider is local with respect to the location of the user.

In an embodiment, the call center is a voice over internet protocol call center.

In an embodiment, the system has a second service provider accessible by the database and the computer network wherein the second service provider provides a service to the user based on the file associated with the user.

In an embodiment, the system has media stored in the database wherein the website promotes the first service provider by displaying the media.

In an embodiment, the system has a financial institution accessible by the database and the first service provider wherein a payment associated with the first service provider is processed by the financial institution.

In another embodiment of the present invention, a method for collecting and managing data of a user is provided. The method has the step of inputting data of the user into a website wherein the website is accessible via a computer network wherein a location of the user is identifiable from the data input by the user. Further, the method has the step of connecting the user with voice over internet protocol communications via the computer network wherein the voice over internet protocol communications access the data input by the user via the computer network. Still further, the method has the step of identifying a service provider corresponding to the location of the user wherein the service provider is accessible via the computer network. Moreover, the method has the steps of transferring the user and the data of the user to the service provider with the voice over internet protocol communications via the computer network and creating an electronic file accessible by the service provider wherein the data of the user is input to the electronic file via the voice over internet protocol communications.

In an embodiment, the method has the step of sending a communication to the user via the computer network wherein the communication is an electronic mail.

In an embodiment, the method has the step of transmitting software to the service provider via the computer network wherein the software manages the file associated with the user.

In an embodiment, the method has the step of providing a service to the user based on the data of the user.

In an embodiment, the method has the step of interviewing the user via the computer network wherein the service provider inputs information of the user into the electronic file.

In an embodiment, the method has the step of searching the electronic file via the computer network wherein a service is provided to the user based on the data of the user in the file.

In another embodiment of the present invention, a method for collecting and managing data of a user is provided. The method has the step of providing a computer terminal wherein the computer terminal is accessible via a computer network wherein a database is associated with the computer terminal wherein the data of the user is stored in the database. Further, the method has the step of connecting a call center and the user via the computer network wherein the call center is in communication with the computer terminal wherein a location of the user is remote with respect to the call center and the computer terminal wherein the call center communicates with the user via the computer network based on the data of the user. Moreover, the method has the step of transferring the user and the data of the user to a service provider via the call center and the computer network wherein the data of the user is input to an electronic file by the call center via the computer network wherein the service provider provides a legal service.

In an embodiment, the call center is a voice over internet protocol call center.

In an embodiment, the method has the step of managing the electronic file with software wherein the software is accessible via the computer terminal.

In an embodiment, the method has the step of providing a website accessible via the computer network wherein the website promotes the service provider.

In an embodiment, the method has the step of paying a fee via the computer network wherein the fee is based on the legal services provided by the service provider.

In an embodiment, the method has the step of advertising the legal service of the service provider to the user via the computer network.

In an embodiment, the method has the step of inputting the data of the user into the database wherein the database is accessible via the computer network.

It is, therefore, an advantage of the present invention to provide a system and a method for collecting and/or managing data for remote service providers.

Another advantage of the present invention is to provide a system and a method for collecting and/or managing data for remote service providers which may provide a website for inputting information to transfer a client to one of the remote service providers with a call center system.

And, another advantage of the present invention is to provide a system and a method for collecting and/or managing data for remote service providers which may provide a voice over internet protocol (hereinafter “VOIP”) call center for contacting and/or for transferring a client to one of the remote service providers.

Yet another advantage of the present invention is to provide a system and a method for collecting and/or managing data for remote service providers which may integrate a case management web application with a VOIP call center to transfer a client from a host to one of the remote service providers.

A further advantage of the present invention is to provide a system and a method for collecting and/or managing data for remote service providers which may transfer a potential client from a host to one of the remote service providers based on locations of the potential client and one of the remote service providers.

Moreover, an advantage of the present invention is to provide a system and a method for collecting and/or managing data for remote service providers which may display and/or may identify advertising media to a client via a website and a database.

And, another advantage of the present invention is to provide a system and a method for collecting and/or managing data for remote service providers which may populate case management software with information from an online form via a network and/or a VOIP call center.

Yet another advantage of the present invention is to provide a system and a method for collecting and/or managing data for remote service providers which may be available to the remote service providers without a sign-up fee and/or without a termination fee based on a month-to-month agreement.

Another advantage of the present invention is to provide a system and a method for collecting and/or managing data for remote service providers which may provide services in one or more practice areas to a client from one or more of the remote service providers.

Yet another advantage of the present invention is to provide a system and a method for collecting and/or managing data for remote service providers which may provide a network of service providers to render legal services to a client based on a location of the client.

A still further advantage of the present invention is to provide a system and a method for collecting and/or managing data for remote service providers which may provide and/or may offer legal products to the remote service providers based on a practice area of the remote service providers.

Moreover, an advantage of the present invention is to provide a system and a method for collecting and/or managing data for remote service providers which may gather and/or may collect data and/or information from a client via an online form to populate case management software with the data and/or the information for rendering services to the client.

And, another advantage of the present invention is to provide a system and a method for collecting and/or managing data for remote service providers which may provide, may display and/or may broadcast online consumer resources to a client desiring to receive services from one of the service providers.

Yet another advantage of the present invention is to provide a system and a method for collecting and/or managing data for remote service providers which may provide a search engine for identifying parameters within files in case management software to market and/or to provide supplemental services to the clients of the remote service providers.

Moreover, an advantage of the present invention is to provide a system and a method for collecting and/or managing data for remote service providers which may distribute and/or may transfer potential clients to one or more remote service providers for rendering services to the potential clients.

And, another advantage of the present invention is to provide a system and a method for collecting and/or managing data for remote service providers which may integrate a VOIP call center with case management software to provide a website, a blog, a link and/or an update based on services provided by the remote service providers.

Yet another advantage of the present invention is to provide a system and a method for collecting and/or managing data for remote service providers which may integrate a VOIP call center with case management software to provide logs, billing, document preparation, docketing, letter merging, conflict checks and/or security settings.

Another advantage of the present invention is to provide a system and a method for collecting and/or managing data for remote service providers which may transfer a first client and a second client to a first service provider and a second service provider, respectively, based on a location of the first client and a second client, respectively.

Yet another advantage of the present invention is to provide a system and a method for collecting and/or managing data for remote service providers which may provide a third party for referring potential clients to a website and/or to a call center of a host to transfer the potential clients to one of the remote service providers.

A still further advantage of the present invention is to provide a system and a method for collecting and/or managing data for remote service providers which may calculate and/or may communicate fees for the remote service providers based on an amount of files managed by the remote service providers via case management software.

Additional features and advantages of the present invention are described in, and will be apparent from, the detailed description of the presently preferred embodiments and from the drawings.

### BRIEF DESCRIPTION OF THE DRAWINGS

FIG. 1 illustrates a black box diagram of a system for collecting and/or managing data for remote service providers in an embodiment of the present invention.

FIG. 2 illustrates a black box diagram of a system for collecting and/or managing data for remote service providers in an embodiment of the present invention.

FIG. 3 illustrates a flowchart for a method for collecting and/or managing data for remote service providers in an embodiment of the present invention.

### DETAILED DESCRIPTION OF THE PREFERRED EMBODIMENTS

The present invention relates to a system and a method for collecting and/or for managing data for remote service providers. The system and the method may provide a network for integrating a voice over internet protocol (VOIP) call center with case management software to transfer a client from a host to one of the remote service providers. The client may be local with respect to one of the remote service providers to retain and/or to receive services from one of the remote service providers which may be desired by the client. The client may input information and/or data into an online form via a website of the host for identifying a location of the client and/or of one of the remote service providers which may be local with respect to the location of the client. The VOIP call center may contact the client via a telephone and/or the network for inquiring and/or for transferring the client to one of the remote service providers based on the location of the client. An appointment for the client to meet one of the remote service providers may be set and/or may be scheduled by the host, by the VOIP call center and/or by one of the remote service providers.

The host may provide, may transfer and/or may transmit case management software to the remote service providers via the network for rendering and/or for performing the services for the client. The information and/or the data from the online form may populate and/or may be incorporated into a file of the client which may be stored within the case management software of and/or a database of one of the remote service providers. The case management software may organize, may manage and/or may maintain the file of the client and/or the services provided by one of the remote service providers via the database and/or a website. A financial institution may be connectable to and/or may be accessible by the host and/or by the case management software to process transactions associated with the services provided to the client and/or with the remote service providers. The case management software may provide a search engine to identify supplemental services which may be desired by the client based on the information and/or the data of the file of the client.

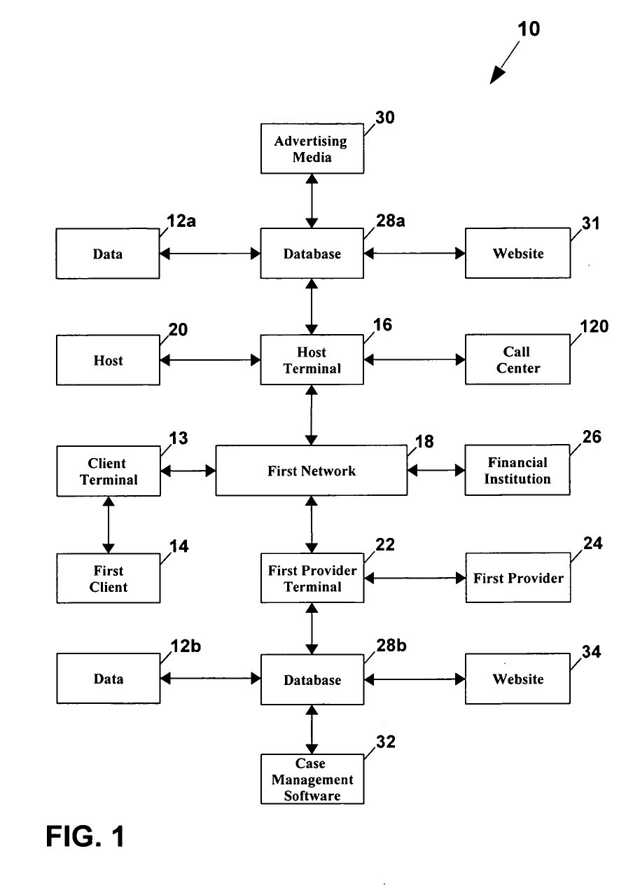

Referring now to the drawings wherein like numerals refer to like parts, FIG. 1 illustrates a system 10 for collecting information and/or data 12a from a first client 14 via a client terminal 13. The system 10 may have a host terminal 16 of a host 20 which may be connected to a first provider terminal 22 of a first provider 24 via a first data communication network 18 (hereinafter “the first network 18”). The client terminal 13 may be connected to and/or may be in communication with the host terminal 16 of the host 20 via the first network 18. The first client 14 and/or client terminal 13 may be remote with respect to the host 20 and/or the host terminal 16. The first client 14 may communication with the host 20 via the client terminal 13, the host terminal 16 and/or the first network 18.

The client terminal 13 may be connected to and/or may be in communication with the first provider terminal 22 of the first provider 24 via the first network 18. The first client 14 and/or the first client terminal 13 may be remote to or may be local with respect to the first provider terminal 22 and/or the first provider 24. The first client 14 may communicate with the first provider 24 via the client terminal 13, the first provider terminal 22 and/or the first network 18.

The system 10 may have a financial institution 26 which may be connected to the host terminal 16 and/or the first provider terminal 22 (collectively known hereinafter as “the terminals 16, 22”) via the first network 18. The terminal 16, 22 and/or the financial institution 26 may be connected to and/or may be in communication with each other via the first network 18. The financial institution 26 may be remote to or may be local with respect to the host 20 and/or the first provider 24. The financial institution 26 may communicate with the host 20 and/or with the first provider 24 via the terminal 16, 22, respectively, and/or the first network 18

The host 20 and the first provider 24 may be connected and/or may be in communication with each other via the first network 18 and/or the terminals 16, 22, respectively. The host 20 may be remote to or may be local with respect to the first provider 24 and/or the first provider terminal 22. The host 20 and the first provider may communicate via the terminal 16, 22 and/or the first network 18.

A database 28a may be connected to and/or may be in communication with the host terminal 16 for delivering and/or for transmitting advertising media 30 to the first client 14 and/or to the first provider 24 via the first network 18. The advertising media 30, the data 12a and/or a website 31 may be stored in and/or may be associated with the database 28a of the host 20. The database 28a may be connected to and/or may be in communication with the host 20 for accessing and/or for delivering the advertising media 30, the data 12a and/or the website 31 to the client terminal 13 and/or to the first provider terminal 22 via the first network 18. The database 28a may be remote to or may be local with respect to the host 20 and/or the host terminal 16. The data 12a, the advertising media 30 and/or the website 31 may be accessed by and/or may be displayed by the client terminal 13 and/or by the first provider terminal 22 to the first client 13 and/or the first provider 24, respectively.

As illustrated in FIG. 1, a database 28b may be connected to and/or may be in communication with the first provider terminal 22 for storing and/or for accessing the data 12a, the data 12b, the advertising media 30, case management software 32 and/or a website 34. The first provider 24 and/or the first provider terminal 22 may access, may obtain and/or may receive the data 12a and/or the advertising media 30 from the host 20 via the first network 18. The database 28b may be remote to or may be local with respect to the first provider terminal 22 and/or the first provider 24. The first provider terminal 22 may access and/or may display the data 12a, the data 12b and/or the advertising media 30 to the first provider 24 via the case management software 32 and/or the website 14b. As a result, the first provider 24 may consume and/or may view the data 12a, the data 12b and/or the advertising media 30 via the first provider terminal 22 with the case management software 32 and/or the website 34.

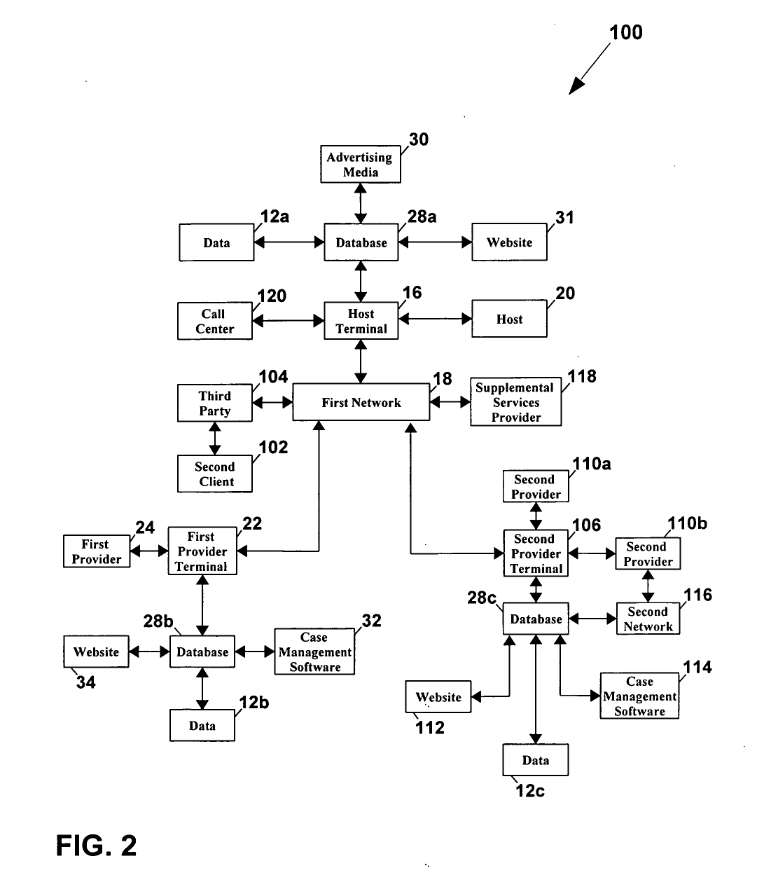

FIG. 2 illustrates a system 100 for collecting and/or for delivering information and/or the data 12a of the second client 102 from a third party 104 and/or from a second client 102. The second client 102 and/or the third party 104 may be connected to and/or may be in communication with the host terminal 16 of the host 20 via the network 18 for accessing and/or for viewing the data 12a, the advertising media 30 and/or the website 31. The second client 102 and/or the third party 104 may be connected to and/or may be in communication with the first provider terminal 22 via the first network 18 for accessing and/or for viewing the data 12b, the case management software 32 and/or the website 34. The second client 102 and/or the third party 104 may be remote to or may be local with respect to each other and/or with respect to the host terminal 16.

A second provider terminal 106 may be connected to and/or may be in communication with the host terminal 16 of the host 20 via the first network 18. The second provider terminal 106 may access the data 12a, the advertising media 30 and/or the website 31 via the database 28a, the host terminal 16 and/or the first network 18. A second provider 110a and/or a second provider 110b (collectively known hereinafter as “the second providers 110a, 110b”) may access and/or may use the second provider terminal 106 to access and/or to view the data 12a, the advertising media 30 and/or the website 31 via the host terminal 16, the first network 18 and/or the second provider terminal 106. A database 28c may be connected to and/or may be in communication with the second terminal 106 for accessing and/or for displaying a website 112, data 12c and/or case management software 114. The website 112, the data 12c and/or the case management software 114 may be stored in and/or may be associated with the database 28c of the second providers 110a, 110b.

The host terminal 16 may access the website 112, the data 12c and/or the case management software 114 of the second providers 110a, 110b via the first network 18, the second provider terminal 106 and/or the database 28c. As a result, the host 20 may access and/or may view the website 112, the data 12c and/or the case management software 114 of the second providers 110a, 110b via the host terminal 16. The second client 102 and/or the third party 104 may access the website 112, the data 12c and/or the case management software 114 of the second providers 110a, 110b via the first network 18, the second provider terminal 106 and/or the database 28c. As a result, the second client 102 and/or the third party 104 may access and/or may view the website 112, the data 12c and/or the case management software 114 of the second providers 110a, 110b via a terminal (not shown in the figures).

A second network 116 may connect the second provider 110b to the database 28c for accessing the website 112, the data 12c and/or the case management software 114. The second provider 110b may be remote to or may be local with respect to the database 28c, the second provider terminal 106 and/or the second provider 11a. A supplemental services provider 118 may connect to the host terminal 16, the first provider terminal 22 and/or the second provider terminal 106 via the first network 18. The supplemental services provider 108 may access and/or may view the data 12a, the advertising media 30 and/or the website 31 of the host 20 via the database 28a, the host terminal 16 and/or the first network 18. The supplemental services provider 118 may access and/or may view the website 34, the data 12b and/or the case management software 32 of the first provider 24 via the database 28b, the first provider terminal 22 and/or the first network 18. The supplemental services provider 118 may access and/or may view the website 112, the data 12c and/or the case management software 114 via the database 28c, the second provider terminal 106 and/or the first network 18.

As shown in FIGS. 1 and 2, the host 20 may be connected to and/or may be in communication with a call center 120 for communicating with, for notifying, for interviewing and/or for instructing the first client 14, the second client 102, the third party 104 and/or the first provider 24. Further, the host 20 may be connected to and/or may be in communication with the call center 120 for communicating with, for notifying, for interviewing and/or for instructing the financial institution 120, the supplemental services provider 118 and/or the second providers 110a, 110b. As a result, the call center 120 may contact and/or may communicate with the first client 14, the second client 102, the third party 104, the first provider 24, the financial institution 26, the supplemental services provider 118 and/or the second providers 110a, 110b. The call center 120 may transfer and/or may transmit the data 12a, the advertising media 30 and/or the website 31 to the first client 14, the second client 102, the third party 104 and/or the financial institution 26. Further, the call center 120 may transfer and/or may transmit the data 12a, the advertising media 30 and/or the website 31 to the supplemental services provider 118, the first provider 24 and/or the second providers 110a, 110b (collectively known hereinafter as “the providers 24, 110a, 110b).

The call center 120 may be, for example, a voice over internet protocol (VOIP) call center which may use voice communications and/or audio signals to contact, to communicate with and/or to interact with the first client 14, the second client 102, the third party 104, the financial institution 26, the supplemental services provider 118 and/or the providers 24, 110a, 110b. A telephone operator (not shown in the figures) of the host 20 may use the call center 120 to communicate with, to contact and/or to interact with the first client 14, the second client 102, the third party 104, the financial institution 26, the supplemental services provider 118 and/or the providers 24, 110a, 110b. The call center 120 may be any call center which may communicate with, contact and/or interact with the first client 14, the second client 102 and/or the third party 104 over the first network 18 as known to one of ordinary skill in the art.

The client terminal 13, the host terminal 16, the first provider terminal 22 and/or the second provider terminal 106 may be, for example, a computer terminal, a mobile device and/or an electronic device for receiving, processing, and/or displaying the information via the first network 18 and/or the second network 116 (collectively known hereinafter as “the networks 18, 116”). In an embodiment, the mobile device may be, for example, a 4G mobile device, a 3G mobile device, an internet protocol (hereinafter “IP”) video cellular telephone, an ALL-IP electronic device, a PDA, a laptop computer, a mobile cellular telephone, a satellite radio receiver, a portable digital audio player, a portable digital video player and/or the like. It should be understood that the client terminal 13, the host terminal 16, the first provider terminal 22 and/or the second provider terminal 106 may be any terminal that may transmit, receive, process and/or display the information via the networks 18, 116 as known to one having ordinary skill in the art.

The networks 18, 116 may be a fixed network, such as, for example, a cabled network, a permanent network and/or the like. In an embodiment, the networks 18, 116 may be a temporary network, such as, for example, a modem network, a null modem network and/or the like. In an embodiment, the networks 18, 116 may be, for example, a local area network, a metropolitan area network, a wide area network, a personal area network and/or the like. Alternatively, the networks 18, 116 may be a wireless network, such as, for example, a wireless metropolitan area network, a wireless local area network, a wireless personal area network, a global standard network, a personal communication system network, a pager-based service network, a general packet radio service, a universal mobile telephone service network, a radio access network, a general-purpose packet-switched network and/or the like. The present invention should not be limited to a specific embodiment of the networks 18, 116. It should be understood that the networks 18, 116 may be any network that may deliver the information, the data 12a, the advertising media 30 and/or the website 31 to the client terminal 13, the first provider terminal 22, the third party 104 and/or the second client 102 and/or the second provider terminal 106 as known to one having ordinary skill in the art.

The providers 24, 110a, 110b may provide and/or may render, for example, professional services, such as, for example, legal services, medical services, accounting services, financial services and/or the like. In an embodiment, the legal services may be in a practice area, such as, for example, criminal law, immigration law, tax law, social security law, workers' compensation law, class-action law, property law, bankruptcy law, tribal law, corporate law, intellectual property law, tort law, divorce law, personal injury law and/or the like. The present invention should not be deemed as limited to a specific type of professional services provided by the providers 24, 110a, 110b.

The first client 14 and/or the second client 102 may desire to receive the professional services provided by and/or rendered by the providers 24, 110a, 110b. In an embodiment, the first client 14 and/or the second client 102 may desire to receive the legal services which may be offered by the first provider 24 and/or by the second providers 110a, 110b. In an embodiment, the first client 14 and/or the second client 102 may desire to receive legal services in the practice area of bankruptcy law which may be provided by the first provider 24 and/or by the second providers 110a, 110b. The present invention should not be deemed as limited to the professional services desired by the first client 14 and/or the second client 102.

The third party 104 may provide affiliated services which may be associated with the professional services of the providers 24, 110a, 110b. In an embodiment, the affiliated services may be associated with the legal services which may be provided and/or may be rendered by the providers 24, 110a, 110b. In an embodiment, the third party 104 may be, for example, a debt consolidation company, a lending company, a debt settlement company, a bank, a credit counseling agency, a provider of debtor education and/or the like. The present invention should not be deemed as limited to a specific type of the third party 104 and/or of the affiliated services which may be provided by the third party 104.

The financial institution 26 may provide transactional services, such as, for example, online payment processing, telephone payment processing, automated bank account payment processing and/or the like. In an embodiment, the financial institution 26 may be a credit card company, a bank, a credit union, a lending company and/or the like. The present invention should not be deemed as limited to a specific type of the financial institution 26 and/or of the transactional services rendered by the financial institution 26.

The supplemental services provider 118 may provide and/or may render supplemental services which may be desired by the first client 14 and/or the second client 102. In an embodiment, the supplemental services may be associated with and/or may relate to mortgage services, financial services, insurance services, educational services, therapy services, physical therapy, employment services, relocation services, job-placement services, home healthcare services and/or the like. In an embodiment, the supplemental services may correspond to, may be based on and/or may be associated with the professional services which may be rendered by the providers 24, 110a, 110b. In an embodiment, the supplemental services provided by the supplemental services provider 118 may be financial services associated with the legal services which may be provided by the first provider 24 and/or the second provider 110a, 110b. It should be understood that the supplemental services may be any services which may be associated with and/or may be based on the professional services provided by the providers 24, 110a, 110b as known to one of ordinary skill in the art.

The host 20 and/or the supplemental services provider 118 may provide and/or may offer a product (not shown in the figures) to the first user 14, the second user 102, the third party 104, the first provider 24, the second providers 110a, 110b and/or the financial institution 26 via the first network 18. The first user 14, the second user 102, the third party 104, the first provider 24, the second providers 110a, 110b and/or the financial institution 26 may purchase and/or may receive the product from the host 20 and/or the supplemental services provider 118 via the first network 18. Alternatively, the product may be delivered to the first user 14, the second user 102, the third party 104, the first provider 24, the second providers 110a, 110b and/or the financial institution 26 via a common carrier, a postal service, an airmail service and/or the like.

The product offered by the host 20 and/or by the supplemental services provider 118 may relate to, may be based on and/or may be associated with the professional services which may be provided by and/or may be rendered by the providers 24, 110a, 110b. In an embodiment, the product may relate to and/or may be associated with the supplemental services which may be provided by and/or may be rendered by the supplemental services provider 118. In an embodiment, the product may relate to and/or may be associated with tax services, marketing services, lead generation services, legal services and/or the like. In an embodiment, the product may relate to and/or may be associated with research tools, document preparation, financial products, insurance products, a pre-filing credit counseling briefing, a post-filing debtor educational course, a credit report, a home valuation, a tax transcript and/or a due diligence product. In an embodiment, the product may be VOIP-enabled hardware, internet telephony, and/or a digital telephone for connecting to and/or for accessing the call center 120 of the host 20 via the first network 18. It should be understood that the product may be any product associated with the professional services provided by the first provider 24 and/or by the second providers 110a, 110b as known to one of ordinary skill in the art.

The product received from the host 20 and/or from the supplemental services provider 118 may aid and/or may assist the providers 24, 110a, 110b with providing, with performing and/or with rendering the professional services for the first client 14 and/or the second 102 (collectively known hereinafter as “the clients 14, 102”). Further, the product may be a required document associated with the professional services being provided and/or being rendered by the providers 24, 110a, 110b. For example, the product may be the pre-filing credit counseling briefing which may be completed by the clients 14, 102 to fulfill a requirement associated with bankruptcy law. The pre-filing credit counseling briefing may be accessed and/or may be completed by the clients 14, 102 for filing a bankruptcy petition for the clients 14, 102 by the providers 24, 110a, 110b.

The host 20 may provide, for example, marketing services, business consulting services, business support services and/or the like. The host 20 may market, may advertise and/or may promote the professional services of the first provider 24 and/or of the second providers 110a, 110b. The host 20 may use the advertising media 30, the website 31, the host terminal 16 and/or the first network 18 to market, to advertise and/or to promote the providers 24, 110a, 110b. In an embodiment, the host 20 may use marketing strategies to attract the first client 14, the second client 102 and/or the third party 104 to the professional services which may be provided by the first provider 24 and/or by the second providers 110a, 110b.

The host 20 may use the marketing strategies to attract the first client 14, the second client 102 and/or the third party 104 to the first provider 24 in a first location and/or to the second providers 110a, 110b in a second location. The first location of the first provider 24 may be remote with respect to the second location of the second providers 110a, 110b. In an embodiment, a location of the first client 14, the second client 102 and/or the third party 104 may be used with the marketing strategies to promote, to market and/or to advertise the providers 24, 110a, 110b.

The marketing strategies used by the host 20 may be related to and/or may be based on, for example, practice area specific websites, paid online marketing, natural search marketing, mail marketing and/or the like. In an embodiment, the marketing strategies used by the host 20 may be related to and/or may be based on viral marketing, affiliate marketing, inter-company marketing, intra-company marketing and/or the like. It should be understood that the marketing strategies used by the host 20 may be any marketing strategies capable of promoting, advertising and/or marketing the providers 24, 110a, 110b as known to one of ordinary skill in the art.

The providers 24, 110a, 110b may desire to be associated with the host 20 to obtain the marketing services, the business consulting services and/or the business support services offered by and/or provided by the host 20. The providers 24, 110a, 110b may desire to use the marketing strategies which may be provided by the host 20 to market, to advertise and/or to promote the professional services of the providers 24, 110a, 110b. Further, the providers 24, 110a, 110b may desire to use the advertising media 30 and/or the website 31 of the host 20 for marketing, for advertising and/or for promoting the professional services of the providers 24, 110a, 110b. Moreover, the providers 24, 110a, 110b may desire to use the product which may be provided by the host 20 for providing, for performing and/or for rendering the professional services for the clients 14, 102. As a result, the providers 24, 110a, 110b may contact and/or may retain the host 20 for marketing, for advertising and/or for promoting the professional services of the provider 24, 110a, 110b to the clients 14, 102 via the first network 18.

In an embodiment, the first provider 24 may desire the host 20 to market, to advertise and/or to promote the professional services of the first provider 24 via the first network 18, the advertising media 30 and/or the website 31. The data 12a, the advertising media 30, the data 12b, the case management software 32, the website 34 and/or the product may be provided to the first provider 24 via a first membership. For example, the first provider 24 may be a divorce attorney which may desire to have the host 20 advertise and/or promote the legal services of the first provider 24 to a divorce client via the website 31, the advertising media 30 and/or the first network 18. Further, the product provided by the host 20 to the first provider 24 may be an intake form associated with, for example, divorce law which may aid and/or may assist the first provider 24 in providing and/or in rendering the professional services for the clients 14, 102.

The first membership may be an agreement between the host 20 and the first provider 24 for accessing, for receiving and/or for using the data 12a, the advertising media 30, the data 12b, the case management software 32, the website 34 and/or the product. The first provider 24 may not be charged an initial fee for entering into the agreement with the host 20. The host 20 may transmit and/or may transfer the data 12a, the advertising media 30, the data 12b, the case management software 32, the website 34 and/or the product to the database 28b of the first provider 24 in the first location based on the first membership of the first provider 24. As a result, the first provider 24 may use and/or may access the data 12a, the advertising media 30, the website 31, the website 34, the case management software 32, the data 12b and/or the product for managing, for organizing and/or for maintaining client files based on the professional services which may be provided by and/or may be rendered by the first provider 24.

The second providers 110a, 110b may desire the host 20 to market, to advertise and/or to promote the professional services of the second providers 110a, 110b via the first network 18, the advertising media 30, the host terminal 16 and/or the website 31. In an embodiment, the data 12a, the advertising media 30, the data 12c, the case management software 114, the website 112 and/or the product may be provided to the second providers 110a, 110b via a second membership. The second membership may be an agreement between the host 20 and the second providers 110a, 110b for accessing, for receiving and/or for using the data 12a, the advertising media 30, the website 31, the data 12c, the case management software 114, the website 112 and/or the product. The second providers 110a, 110b may not be charged an initial fee for entering into the agreement with the host 20. The host 20 may transmit and/or may transfer the data 12a, the advertising media 30, the data 12c, the case management software 114, the website 112 and/or the product to the database 28c of the second providers 110a, 110b in the second location based on the second membership. The second providers 110a, 110b may use and/or may access the website 112, the case management software 114, the data 12c and/or the product for managing, for organizing and/or for maintaining client files based on the professional services which may be rendered by the second providers 110a, 110b. As a result, the system 10 and/or the system 100 may integrate and/or may incorporate the call center 120 of the host 20 with the case management software 32 of the first provider 24 and/or the case management software 114 of the second provider 102.

The first membership and/or the second membership may be valid for a term duration of time for the host 20 to promote, to advertise and/or to market the providers 24, 110a, 110b, respectively. The term duration of time may be, for example, one month, three months, six months and/or one year. The first membership and/or the second membership may be renewed via the call center 120, the host terminal 16, the first provider terminal 22 and/or the second provider terminal 106, respectively. As a result, the first membership and/or the second membership may be extendable by the providers 24, 110a, 110b, to a date in time beyond the term duration of time. For example, the term duration of time for the first membership of the first provider 24 may be one month. The first provider 24 may access the host terminal 16 via the first provider terminal 22 and/or the first network 18 to renew the first membership of the first provider 24. As a result, the first membership of the first provider 24 may be extended for one month based on the term duration of time for the first membership of the first provider 24.

A user fee may be associated with, may be charged for and/or may be due for the first membership and/or the second membership. The user fee may correspond to and/or may be based on files associated with the clients 14, 102 of the providers 24, 110a, 110b, respectively, which may be managed, may be organized and/or may be maintained via the case management software 32 and/or the case management software 114, respectively. In an embodiment, the user fee may be associated with a cost of marketing to the host 20, with a licensing fee for populating and/or for providing the data 12b and/or the data 12c and/or with expenses related to the call center 120.

The case management software 32 and/or the case management software 114 (collectively known hereinafter as “the case management softwares 32, 114”) which may be provided to the providers 24, 110a, 110b, respectively, by the host 20 may have a processor programmed to manage the number of files associated with the clients 14, 102. In an embodiment, the processor may relate to and/or may be associated with research tools, VOIP systems, payment processing services, website development, pay per click campaign management and/or the like. In an embodiment, the processor may relate to and/or may be associated with answer services, appointment setting services, a group insurance coverage, a document preparation, a document storage, a creation of directory sites, information technology consulting, a security setting, conflict checking services, prospect management tools and/or the like.

In an embodiment, the processor may allow the providers 24, 110a, 110b to manage files of the clients 14, 102 to log and/or to track billing information, to track case activity associated with the clients 14, 102 and/or to docket deadlines, dates, appearances, milestones, events and/or occasions associated with the clients 14, 102, the files of the clients 14, 102 and/or the professional services provided by the first provider 24 and/or by the second providers 110a, 110b. The billing information may relate to and/or may be associated with client fees for the clients 14, 102 of the providers 24, 110a, 110b. In an embodiment, the processor may allow the second providers 110a, 110b to assign and/or to distribute inquiries of the clients 14, 102 between the second provider 110a and the second provider 110b.

The client fees may relate to and/or may be associated with filing fees, costs, expenses and/or the professional services rendered by the providers 24, 110a, 110b to manage, to maintain and/or to expedite the files of the clients 14, 102, the first client 14, the second client 102 and/or the third party 104. The processor of the case management software 32 and/or of the case management software 114 may accept and/or may process a payment of the user fees for the first membership and/or for the second membership via the transactional services of the financial institution 26. Further, the processor of the case management software 32 and/or of the case management software 114 may accept and/or may process a payment of the client fees for the clients 14, 102 of the providers 24, 110a, 110b, respectively, via the transactional services of the financial institution 26.

The transactional services of the financial institution 26 may complete the payment of the user fees and/or of the client fees via the first network 18. In an embodiment, the processor of the case management software 32 and/or of the case management software 114 may deduct the user fees and/or the client fees from a bank account associated with the clients 14, 102, the third party 104 and/or the providers 24, 110a, 110b. The clients 14, 102, the third party 104 and/or the providers 24, 110a, 110b may pay for the user fees and/or the client fees via the website 34 of the first provider 24 and/or the website 114 of the second providers 110a, 110b via the first network 18.

The processor may identify, may record and/or may store parameters associated with the clients 14, 102, the files of the clients 14, 102 and/or the professional services rendered by the first providers 24 and/or the second providers 110a, 110b via the database 28b and/or the database 28c, respectively. The parameters may be, for example, a date of initial contact, an associate assigned to provide the legal services to the clients 14, 102, a court associated with the files of the clients 14, 102, a judge associated with the files of the clients 14, 102 and/or the like. In an embodiment, the parameters may be, for example, case information associated with the files of the clients 14, 102, summary information associated with the files of the clients 14, 102 and/or pre-populated information associated with the files of the clients 14, 102. As a result, the parameters may allow the processor to manage and/or to maintain the files of the clients 14, 102. It should be understood that the parameters may be any parameters which may be associated with the files of the client as known to one of ordinary skill in the art.

The call center 120 and/or the case management softwares 32, 114 may have, for example, an email functionality for generating, for sending and/or for transmitting one or more emails from the call center 120, the first provider terminal 22 and/or from the second provider terminal 106, respectively, to the clients 14, 102, respectively, via the first network 18. A template library (not shown in the figures) corresponding to the email functionality may be stored in the database 28a, the database 28b and/or the database 28c (collectively known hereinafter as “the databases 28a-28c”) for creating and/or for generating one or more emails for the clients 14, 102, respectively. As a result, the email functionality may create and/or may generate an automated email messaging via the template library for contacting, for communicating with and/or for notifying the clients 14, 102 of the providers 24, 110a, 110b, respectively. Further, the email functionality may transmit an automated email messaging via the template library for the call center 120 to contact and/or to communicate with the clients 14, 102 via the network 18.

In an embodiment, the website 31 and/or the database 28a of the host 16 may contain a keyword for marketing, for advertising and/or for promoting the host 16, the financial institution 26, the supplemental services provider 118 and/or the providers 24, 110a, 110b. The keyword associated with the website 31 and/or with the database 28a of the host 20 may be searchable by a search engine associated with the client terminal 13, with the second client 102 and/or with the third party 104 for identifying the host 20 in results obtainable from the search engine. In an embodiment, the keyword associated with the website 31 and/or with the database 28a may be searchable by a search engine via the first network 18 which may be provided by a professional search engine. It should be understood that the keyword associated with the website 31 and/or with the database 28a may be searched by any search engine as known to one of ordinary skill in the art.

The keyword associated with the website 31 and/or with the database 28a may increase a probability that the clients 14, 102 and/or the third party 104 may access and/or may select the host 20 from the results of the search engine. As a result, the keyword may increase the probability that the clients 14, 102 and/or the third party 104 may access, may display, may consume, may identify and/or may view the website 31 of the host 20. The clients 14, 102 and/or the third party 104 may access and/or may select the website 31 and/or the host 20 from the results of the search engine via the database 28a, the host terminal 16 and/or the first network 18. As a result, the clients 14, 102 and/or the third party 104 may access, may view, may consume and/or may display the website 31 of the host 20 via the database 28a, the host terminal 16 and/or the first network 18.

The website 31, the website 34 and/or the website 112 (collectively known hereinafter as “the websites 31, 34, 112”) may contain and/or may display service information associated with and/or based on the providers 24, 110a, 110b and/or the professional services rendered by the providers 24, 110a, 110b, respectively. In an embodiment, the service information may be associated with a requirement to qualify for the professional services, a procedure and/or a process of the professional services, a repercussion and/or a result of the professional services, fees and time frames for the professional services and/or the like. For example, the service information may display steps and/or procedures which may be completed prior to filing a workers' compensation petition or a time frame associated with obtaining a settlement from a personal injury lawsuit.

The websites 31, 34, 112 may contain and/or may display online consumer resources (not shown in the figures) for consuming by and/or for use by the clients 14, 102 and/or the third party 104 via the first network 18 and/or the first provider terminal 22 and/or the second provider terminal 106, respectively. In an embodiment, the online consumer resources may be practice information corresponding to the practice area of the providers 24, 110a, 110b and/or the professional services of the providers 24, 110a, 110b.

In an embodiment, the online consumer resources may be a news article, a graphical table, a calculator, an evaluation, a qualification test, a resource link, an online inquiry, a blog, a newsletter and/or an update associated with the practice area of the providers 24, 110a, 110b. In an embodiment, the online consumer resources may be a calculator, a credit counseling certification, a due diligence package and/or a debtor education course. It should be understood that the online consumer resources may be any online resource which may be usable by the clients 14, 102 and/or the provider 24, 110a, 110b as known to one of ordinary skill in the art.

The clients, 14, 102 may desire to learn and/or to be informed about the professional services which may be offered by the providers 24, 110a, 110b via the first network 18. The clients 14, 102 may desire to obtain, to display, to view and/or to consume the service information and/or the online consumer resources associated with the professional services of the providers 24, 110a, 110b via the websites 31, 34, 112. For example, the first client 14 may desire to learn about the legal services in the practice area of bankruptcy law which may be offered by the second providers 110a, 110b via the client terminal 13 and/or the first network 18. The first client 14 may access and/or may use the search engine to search a keyword associated with the practice area of bankruptcy law and/or the second providers 110a, 110b. The first user 14 may desire to be informed about the practice arre of bankruptcy law by selecting and/or by accessing the website 31 of the host 20 from the results of the search engine via the client terminal 13. The first user 14 may display, may view and/or may consume the service information and/or the online consumer resources associated with the practice area of bankruptcy law via the website 31, the client terminal 13 and/or the first network 18. As a result, the first client 14 may learn and/or may be informed about requirements and/or qualifications for filing a bankruptcy petition.

The websites 31, 34, 112 may be displayed to and/or may be consumed by the clients 12, 102 and/or the third party 104 in a configuration and/or a format via the first network 18. The configuration and/or the format of the websites 31, 34, 112 may be based on, may be designed by, may be arranged by and/or may be customized by one or more design elements which may be stored in the databases 28a-28c, respectively. In an embodiment, the one or more design elements may be a graphic, content, a color, text, a logo, a photograph, a surname, a quote, a trademark, a map, a slogan, a border, a wall paper, a pull-down option box and/or the like. It should be understood that the design elements may be any design element that may effect the configuration and/or the format of the websites 31, 34, 112 as known to one of ordinary skill in the art.

The configuration and/or the format of the websites 31, 34, 112 may be generated by the host terminal 16 and/or the case management softwares 32, 114, respectively. The configuration and/or the format of the websites 31, 34, 112 may be randomly generated based on a test for increasing conversions of visitors of the website 31 to the clients 14, 102 of the providers 24, 110a, 110b, respectively. In an embodiment, the host terminal 16 and/or the management softwares 32, 114 may be programmed to randomly generate the configuration and/or the format of the websites 31, 34, 112, respectively, from the design elements which may be stored in the databases 28a-28c, respectively. In an embodiment, the configuration and/or the format of the websites 31, 34, 112 may be manually customized by the host 20 and/or the providers 24, 110a, 110b, respectively. It should be understood that the websites 31, 34, 112 may be generated and/or may be customized by any method as known to one of ordinary skill in the art.

The websites 31, 34, 112 may display and/or may render the advertising material 30 to the clients 14, 102 and/or the third party 104. The advertising media 30 may be, for example, a commercial, an advertisement, an audio transmission, a video, an interview, a commentary, a documentary, a banner advertisement, a visual display, a graphical advertisement and/or the like. In an embodiment, the advertising material 30 may relate to, may be associated with and/or may correspond to the host 20, the providers 24, 110a, 110b, the third party 104, the financial institution 26, and/or the supplemental services provider 118. In an embodiment, the advertising media 30 may relate to, may be associated with and/or may correspond to the professional services which may be provided by the host 20, the providers 24, 110a, 110b, the financial institution 26 and/or the supplemental services provider 118. It should be understood that the advertising media 30 may be any type of media as known to one of ordinary skill in the art.

The advertising material 30 may display and/or may contain contact information for the host 20 and/or the providers 24, 110a, 110b via the website 31 of the host 20. The clients 14, 102 and/or the third party 104 may consume and/or may view the contact information of the advertising material 30 via the host terminal 16, the website 31 and/or the network 18 for contacting the host 20. The contact information may be, for example, an email address for the host 20, a telephone number for the call center 120, a mailing address for the host 20 and/or a Uniform Resource Locator address for the website 31, a web address for the website 31, an online form and/or the like. It should be understood that the contact information may be any information which may allow the host 20 to identify and/or to contact the clients 14, 102 as known to one of ordinary skill in the art.

The online form may be associated with, may be based on and/or may correspond to the professional services which may be rendered by and/or may be provided by the providers 24, 110a, 110b to the clients 24, 102, respectively. The clients 14, 102 may input and/or may submit a first location and/or a second location, respectively, of the clients 14, 102, respectively via the online form. In an embodiment, the online form may correspond to a legal evaluation form and/or to a service qualification for determining whether the clients 14, 102 may be entitled to receive, may qualify for and/or may be eligible for the professional services from the providers 24, 110a, 110b.

The host terminal 16 may deliver, may distribute, may stream, may broadcast and/or may transmit the advertising media 30 to the client terminal 13, the first provider terminal 22, the third party 104, the financial institution 26, the supplemental services provider 118 and/or the second provider terminal 106 via the website 31 and/or the first network 18. As a result, the advertising media 30 may be consumed by, may be displayed to, and/or may be rendered to the clients 14, 102, the third party 104, the providers 24, 110a, 110b, the financial institution 26 and/or the supplemental services provider 118. It should be understood that the advertising media 30 may be transmitted via the first network 16 by any means of transmission as known to one having ordinary skill in the art.

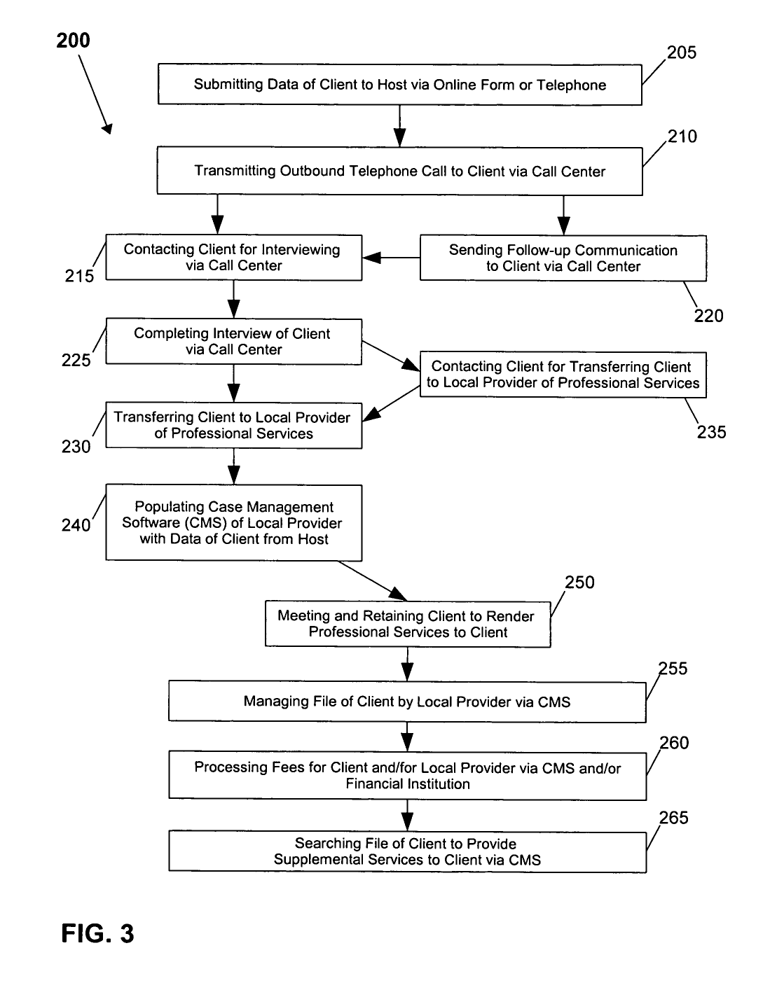

FIG. 3 illustrates a flowchart for a method 200 for collecting and/or for managing the data 12a of the clients 14, 102. After selecting and/or accessing the website 31 from the results of the search engine based on the keyword, the clients 14, 102 may view and/or may consume the advertising material 30 of the host 20, the service information for the professional services, the online consumer resources for the professional services and/or the contact information of the host 20. The clients 14, 102 may input and/or may submit the data 12a into the online form on the website 31 as shown at step 205. The clients 14, 102 may input and/or may submit the first location of the first client 14 and/or the second location of the second client 102 into the online form of the website 31. The data 12a may be associated with, may be based on and/or may correspond to client information for the clients 14, 102. In an embodiment, the client information for the clients 14, 102 may be biographical information, financial information, employment information, personal information and/or the like. It should be understood that the client information may be any information associated with the clients 14, 102 and/or with the professional services of the providers 24, 110a, 110b as known to one of ordinary skill in the art.

Alternatively, the clients 14, 102 may contact the telephone operator at the call center 120 of the host 20 via the contact information and/or a telephone. The telephone operator at the call center 120 may interview the clients 14, 102 to submit the data 12a of the clients 14, 102 to the host 20 via the call center 120. Further, the telephone operator may obtain the first location of the first user 14 and/or the second location of the second user 102 from the clients 14, 102, respectively, in the interview via the telephone.

After the data 12a of the clients 14, 102 may be submitted to the host 20 via the online form, the telephone operator at the call center 120 of the host 20 may place and/or may transmit an outbound call from the call center 120 to the clients 14, 102 as shown at step 210. The telephone operator at the call center 120 may contact, may discuss and/or may interview the clients 14, 102 to obtain and/or the complete the data 12a of the clients 14, 102 as shown at step 215. The clients 14, 102 may not be available to receive the outbound telephone call from the call center 120 and may have to be interviewed at a later time. The telephone operator at the call center 120 may place, may send and/or may transmit one or more follow-up communications to the clients 14, 102 for contacting and/or for interviewing the clients 14, 102 as shown at step 220.

The follow-up communications may be, for example, outbound telephone calls from the call center 120, emails from the email functionality of the host, mailings from the host 20 to contact and/or to interview the clients 14, 102. The follow-up communications from the call center 120 may be based on the data 12a of the clients 14, 102 which may have been collected in the online form on the website 31. The follow-up communications may be any communications which may contact and/or may interview the clients 14, 102 as known to one of ordinary skill in the art.

The telephone operator at the call center 120 may initiate an interview of the clients 14, 102 to discuss the data 12a, the professional services offered by the providers 24, 110a, 110b, the service information associated with the professional services via the outbound telephone call and/or the follow-up communications. The clients 14, 102 may learn about the professional services offered by the providers 24, 110a, 110b, the service information associated with the professional services via the telephone operator and/or the call center 120. The telephone operator at the call center 120 may obtain the first location and/or the second location of the clients 14, 102, respectively, via the outbound telephone call and/or the follow-up communications. The telephone operator at the call center 120 may complete the interview to determine whether the clients 14, 102 may qualify for the professional services of the providers 24, 110a, 110b as shown at step 225.

The telephone operator at the call center 120 and/or the host terminal 16 may store the first location of the first user 14 and/or the second location of the second user 102 in the data 12a of the clients 14, 102, respectively. The telephone operator at the call center 120 and/or the host terminal 16 may store the data 12a of the clients 14, 102 in the database 28a of the host 20. The telephone operator at the call center 120 may determine whether the clients 14, 102 may qualify for the professional services of the providers 24, 110a, 110b based on the data 12a of the clients 14, 102, the first location and the second location of the clients 14, 102 and/or the interview with the clients 14, 102.

The telephone operator at the call center 120 may determine whether the first location of the first client 14 may match and/or may be local with respect to the first location of the first provider 24. Further, the telephone operator at the call center 120 may determine whether the second location of the second client 102 may match and/or may be local with respect to the second providers 110a, 110b. The first location of the first client 14 may be local with respect to the first location of the first provider 24. The second location of the second user 102 may be local with respect to the second providers 110a, 110b. For example, the second user 102 and the second providers 110a, 110b may reside and/or may be located in, for example, a city, a town, a village, a county, a suburb and/or a district.

The first location and/or the second location of the clients 14, 102, respectively, may match and/or may be local with respect to the first location and/or the second location of the providers 24, 110a, 110b, respectively. The telephone operator may contact the first provider 24 via the telephone and/or the call center 120 to transfer the first client 14 to the first provider 24 based on the first location of the first client 14 and the first provider 24. Further, the telephone operator may contact the second providers 110a, 110b via the telephone and/or the call center 120 to transfer the second client 102 to the second providers 110a, 110b based on the second location of the second client 102 and the second providers 110a, 110b. The telephone operator may introduce and/or may transfer the clients 14, 102 to the providers 24, 110a, 110b, respectively, via the telephone and/or the call center 120 as shown at step 230.

In an embodiment, the telephone operator and/or the clients 14, 102 may terminate the outbound telephone call with completion of the interview of the clients 14, 102. The telephone operator may contact the clients 14, 102 with a follow-up telephone call to introduce and/or to transfer the clients 14, 102 to the providers 24, 110a, 110b, respectively, via the call center 120 as shown at step 235. As a result, the telephone operator may introduce and/or may transfer the clients 14, 102 to the providers 24, 110a, 110b, respectively, via the follow-up telephone call and/or the call center 120 as shown at step 230.

The call center 120 may transfer and/or may transmit the data 12a of the first client 14 to the first provider 24 via the network 18 with introducing and/or transferring the first client 14 to the first provider 24. The call center 120 may transfer and/or may transmit the data 12a of the second client 102 to the second providers 110a, 110b via the network 18 with introducing and/or transferring the second client 102 to the second providers 110a, 110b. As a result, the data 12b and/or the case management software 32 of the first provider 24 may be populated with and/or may be programmed with the data 12a of the first client 14 via the call center 120 as shown at step 240. Further, the data 12c and/or the case management software 114 of the second providers 110a, 110b may be populated with and/or may be programmed with the data 12a of the second client 102 via the call center 120. The case management softwares 32, 114 may generate, may create, may open and/or may store an electronic file (not shown in the figures) associated with the clients 14, 102, respectively, in the database 28b and/or the database 28c, respectively. The electronic file associated with the clients 14, 102 may be associated with the data 12b and the data 12c, respectively, of the clients 14, 102, respectively.

The first provider 24 may interview the first client 14 to determine whether the first client 14 may qualify to receive the professional services of the first provider 24. The first provider 24 may review the data 12b and/or the electronic file of the first client 14 to determine whether the first client 14 may qualify to receive the professional services of the first provider 24. The first client 14 may interview the first provider 24 to learn about the first provider 24 and/or the professional services of the first provider 24. Further, the first client 14 may interview the first provider 24 to determine whether to retain the professional services of the first provider 24.

The first client 14 may qualify for the professional services of the first provider 24, and the first client 14 may desire to retain the first provider 24. The first provider 24 may use the appointment setting services of the case management software 32 to schedule a meeting and/or an appointment with the first client 14. The first client 14 may meet with and/or may retain the professional services of the first provider 24 via a service agreement between the first client 14 and the first provider 24 as shown at step 250.

In an embodiment, the second providers 110a, 110b may not be available to receive and/or to be introduced to the second client 102 by the call center 120 and/or the telephone operator. The call center 120 may transmit and/or may send the data 12a of the second client 102 to the second provider terminal 106 via the first network 18 and/or the host terminal 16. The data 12a of the second client 102 may be stored in the database 28c by the case management software 114 the second providers 110a, 110b. The data 12a of the second client 102 which may be transmitted from the call center 120 may populate and/or may be programmed into the case management software 114 and/or the data 12c of the second client. The case management software 114 may generate, may create, may open and/or may store an electronic file corresponding to the second client 102 in the database 18c. The electronic file corresponding to the second client 102 may be associated with the data 12c of the second client 102.

The case management software 114 may generate a lead based on the electronic file of the second client 102 for distributing between the second providers 110a, 110b. Distribution of the lead between the second providers 110a, 110b may be determined by the case management software 114 and/or may be an administrator (not shown in the figures) of the second providers 110a, 110b. Further, the case management software 114 may be programmable to determine the distribution of the lead between the second providers 110a, 110b. The lead may be distributed to the second provider 110a via the database 28c, the second provider terminal 106 and/or the case management software 114. Alternatively, the lead may be distributed to the second provider 110b via the case management software 114 and/or the second network 116. The second provider 110b may remote to or may be local with respect to the second provider terminal 106, the database 28c and/or the case management software 114. The second provider terminal 106 and/or the second provider 110a may communicate with the second provider 110b via the second network 116.

In an embodiment, the lead may be distributed to the second provider 110a for contacting and/or for interviewing the second client 102 to discussing the professional services of the second providers 110a, 110b. The lead may be associated with the electronic file of the second client 102 which may display a telephone number of the second client 102 for the second provider 110a to contact the second client 102. The second provider 110a may place an outbound telephone call to the second client 102 based on the lead, the electronic file of the second client 102 and/or the data 12c of the second client 102.

The second provider 110a may interview the second client 102 to determine whether the second client 102 may qualify to receive the professional services of the second providers 110a, 110b. The second provider 102 may review the data 12c and/or the electronic file of the second client 102 to determine whether the second client 102 may qualify to receive the professional services of the second providers 110a, 110b. The second client 102 may interview the second provider 110a to learn about the second providers 110a, 110b and/or the professional services of the second providers 110a, 110b. Further, the second client 102 may interview the second provider 102 to determine whether to retain the professional services of the second providers 110a, 110b.

The second client 102 may qualify for the professional services of the second provider 110a, 110b and the second client 102 may desire to retain the second providers 110a, 110b. The second providers 110a, 110b may use the appointment setting services of the case management software 114 to schedule a meeting and/or an appointment with the second client 102. The second client 102 may meet with and/or may retain the professional services of the second providers 110a, 110b via a service agreement between the second client 102 and the second providers 110a, 110b as shown at step 250.

The providers 24, 110a, 110b may provide, may perform and/or may render the professional services for the clients 14, 102, respectively based on the service agreement of the clients 14, 102, respectively. The electronic files of the clients 14, 102 may be modified, may be edited and/or may revised by the providers 24, 110a, 110b, respectively, based on the professional services which may have been provided by the providers 24, 110a, 110b, respectively. As a result, the providers 24, 110a, 110b may manage the electronic files of the clients 14, 102 via the case management softwares 32, 114 as shown at step 255.

For example, the first provider 24 may be providing legal services relating to a bankruptcy petition for the first user 14. The first provider 24 may have filed the bankruptcy petition in the bankruptcy court and/or may have received a hearing date from the bankruptcy court relating to the bankruptcy petition. The first provider 24 may update the electronic file of the first client 14 to include the hearing date for notifying the first client 14 and/or for docketing the hearing date via the first provider terminal 22 and/or the case management software 32. The first provider 24 may transmit an email to the first client 14 for notifying the first client 14 of the hearing date via the case management software 32, the first provider terminal 22, the client terminal 13 and/or via the first network 18. The first provider 24 may manage, may organize and/or may maintain the electronic file of the first client 14 until after expiration and/or termination of the service agreement between the first provider 24 and the first client 14.

The second providers 110a, 110b may provide the professional services for the second client 102 based on the service agreement between the second providers 110a, 110b and the second client 102. As the professional services are performed by the second providers 110a, 110b, a fee associated with the professional services may accrue and/or may require payment by the second providers 110a, 110b. For example, the second providers 110a, 110b may provide legal services associated with a divorce petition for the second client 104. A filing fee may be paid by the second providers 110a, 110b on behalf of the second client 102 for filing the divorce petition in a courthouse. The second client 102 may access the website 112 of the second providers 110a, 110b to pay the fee associated with the professional services of the second providers 110a, 110b. The second client 102 may access the case management software 114 via the website 112 and/or the first network 18 to pay the fee to the second providers 110a, 110b. Alternatively, the financial institution 26 may access the case management software 114 via the website 112 and/or the first network 18 to pay the fee for the second client 102 to the second providers 110a, 110b. The case management software 114 may process a payment of the fee by the second client 102 and/or by the financial institution 26 via the website 112 and/or the first network 18 as shown at step 260.

The host 20 may connect to and/or may communicate with the case management softwares 32, 114 via the first network 18 and/or the host terminal 16 to search the electronic file of the clients 14, 102. The host terminal 16 may search the electronic file of the client 14, 102 to determine whether one of the supplemental services from the supplemental services provider 118 may aid and/or may assist the clients 14, 102 as shown at step 265. The host terminal 16 may determine whether one of the supplemental services from the supplement services provider 118 may aid and/or may assist the clients 14, 102 based on the professional services which may have been performed by the providers 24, 110a, 110b, respectively.

In an embodiment, the first provider 24 may be providing legal services associated to a workers' compensation petition for the first client 14 which may have been filed for a work related injury to the first client 14. The first client 14 may have undergone a surgery to treat the injury of the first client 14. The surgery may have been unsuccessful, and legs of the first client 14 may be paralyzed and/or may be inoperative. The host 20 may search the data 12b and/or the electronic file of the first client 14 via the case management software 32 of the first provider 24, the host terminal 16 and/or the first network 18. The host 20 may identify and/or may determine that the legs of the first client 14 may be paralyzed from the surgery via the case management software 32, the host terminal 16 and/or the first network 18. The host 20 may determine that supplemental services, such as, for example, a wheelchair may aid and/or may assist the first user 14 based on the electronic file and/or the data 12b via the case management software 32. The host 20 and/or the case management software 32 may contact the supplemental services provider 118 to request the supplemental services from the supplemental services provider 118. The host 20 and/or the supplemental services provider 118 may provide and/or may deliver the wheelchair to the first client 14 at the first location based on the data 12b and/or the electronic file of the first client 14.

The systems 10, 100 and the method 200 may collect and/or may manage the data 12a, the data 12b and/or the data 12c for the providers 24, 110a, 110b which may integrate and/or may incorporate the call center 120 and the case management softwares 32, 114 via the first network 18. The first client 14 in a first location may access the website 31 of the host 20 via the first network 18 for submitting the data 12 to the host 20. The advertising media 30 may be displayed to the first client 14 via the website 31 for the first client 14 to identify the professional services provided by the providers 24, 110a, 110b. The call center 120 may contact the first client 14 via the telephone based on the data 12a submitted in the online form on the website 31 and/or the first location of the first client 14. The call center 120 may transfer the first client 14 to the first provider 24 based on the first location of the first client 14. The host 20 may populate and/or may program the case management software 32 with the data 12a submitted by the first client 14 to aid, to assist and/or to support the first provider 24 with performing the professional services to the first client 14.

It should be understood that various changes and modifications to the presently preferred embodiments described herein will be apparent to those skilled in the art. Such changes and modifications may be made without departing from the spirit and scope of the present invention and without diminishing its attendant advantages. It is, therefore, intended that such changes and modifications be covered by the appended claims.

We claim:

1. A system for collecting and managing data associated with a user, the system comprising:
a database wherein a website is associated with the database wherein the database is accessible by a computer network wherein the data of the user is input to the database via the website;
a call center accessible by the database and the computer network wherein the call center communicates with the user via the computer network based on the data of the user wherein a location of the user is identified by the call center or the data of the user wherein a location of the user is remote with respect to the call center; and
a first service provider connectable to the call center via the computer network wherein the first service provider is selected based on the location of the user wherein the call center transfers the user and the data of the user to the first service provider via the computer network wherein the first service provider accesses software via the computer network wherein the data of the user is input into a file via the call center and the computer network wherein the software manages a file associated with the user.

2. The system of claim 1 wherein the first service provider is an attorney.

3. The system of claim 1 wherein a location of the first service provider is local with respect to the location of the user.

4. The system of claim 1 wherein the call center is a voice over internet protocol call center.

5. The system of claim 1 further comprising:
a second service provider accessible by the database and the computer network wherein the second service provider provides a service to the user based on the file associated with the user.

6. The system of claim 1 further comprising:
media stored in the database wherein the website promotes the first service provider by displaying the media.

7. The system of claim 1 further comprising:
a financial institution accessible by the database and the first service provider wherein a payment associated with the first service provider is processed by the financial institution.

8. A method for collecting and managing data of a user, the method comprising the steps of:
inputting data of the user into a website wherein the website is accessible via a computer network wherein a location of the user is identifiable from the data input by the user;
connecting the user with voice over internet protocol communications via the computer network wherein the voice over internet protocol communications access the data input by the user via the computer network;
identifying a service provider corresponding to the location of the user wherein the service provider is accessible via the computer network;
transferring the user and the data of the user to the service provider with the voice over internet protocol communications via the computer network; and
creating an electronic file accessible by the service provider wherein the data of the user is input to the electronic file via the voice over internet protocol communications.

9. The method of claim 8 further comprising the step of:
sending a communication to the user via the computer network wherein the communication is an electronic mail.

10. The method of claim 8 further comprising the step of:
transmitting software to the service provider via the computer network wherein the software manages the file associated with the user.

11. The method of claim 8 further comprising the step of:
providing a service to the user based on the data of the user.

12. The method of claim 8 further comprising the step of:
interviewing the user via the computer network wherein the service provider inputs information of the user into the electronic file.

13. The method of claim 8 further comprising the step of:
searching the electronic file via the computer network wherein a service is provided to the user based on the data of the user in the file.

14. A method for collecting and managing data of a user, the method comprising the steps of:
providing a computer terminal wherein the computer terminal is accessible via a computer network wherein a database is associated with the computer terminal wherein the data of the user is stored in the database;
connecting a call center and the user via the computer network wherein the call center is in communication with the computer terminal wherein a location of the user is remote with respect to the call center and the computer terminal wherein the call center communicates with the user via the computer network based on the data of the user; and
transferring the user and the data of the user to a service provider via the call center and the computer network wherein the data of the user is input to an electronic file by the call center via the computer network wherein the service provider provides a legal service.

15. The method of claim 14 wherein the call center is a voice over internet protocol call center.

16. The method of claim 14 further comprising the step of:
managing the electronic file with software wherein the software is accessible via the computer terminal.

17. The method of claim 14 further comprising the step of:
providing a website accessible via the computer network wherein the website promotes the service provider.

18. The method of claim 14 further comprising the step of:
paying a fee via the computer network wherein the fee is based on the legal services provided by the service provider.

19. The method of claim 14 further comprising the step of:
advertising the legal service of the service provider to the user via the computer network.

20. The method of claim 14 further comprising the step of:
inputting the data of the user into the database wherein the database is accessible via the computer network.
